(19) United States
(12) Patent Application Publication
(10) Pub. No.: US 2007/0243276 A1
(43) Pub. Date: Oct. 18, 2007

(54) Laboratorial extrusion line for the production of conventional and bi-oriented tubular film, with simple commutation between the two techniques

(75) Inventors: Olga Machado De Sousa Carneiro, Braga (PT); Jose Antonio Colaco Gomes Covas, Braga (PT); Helder de Jesus Oliveira Da Costa, Viana do Castelo (PT); Jose Manuel Da Fonseca Neiva De Oliveira, Povoa do Varzim (PT)

Correspondence Address: SUGHRUE MION, PLLC, 2100 PENNSYLVANIA AVENUE, N.W., SUITE 800, WASHINGTON, DC, 20037, US

(73) Assignee: UNIVERSIDADE DO MINHO

(21) Appl. No.: 11/594,874

(22) Filed: Nov. 9, 2006

(30) Foreign Application Priority Data
Nov. 9, 2005 (PT) 103380

(51) Int. Cl. B29C 47/08

(52) U.S. Cl. 425/113

(57) ABSTRACT

The invention refers to a laboratorial extrusion line, illustrated in FIG. 1, that has the ability to be used both for the production of conventional and bi-oriented tubular film (monolayer or multilayer), with simple commutation between the two techniques. The line encompasses two movable extruders (1 and 2), one extrusion die for the production of conventional film (3), one extrusion die for the production of bi-oriented film (4), one unit for the internal calibration/cooling of the primary (5), one water ring for the external cooling of the primary (6), four sets of pulling rolls (7 to 10), three air rings to cool down the film (11 to 13), two units for the thermal conditioning of the primary (14 and 15) and one winding unit (16).

The use of some of the components (1, 3, 11, 8, 10 and 16) enables the production of conventional tubular film, while another set of components (1, 2, 4, 5, 6, 7, 9, 14, 15, 12, 13, 10 and 16) is used for the production of bi-oriented tubular film.

The Priority Document (Portuguese Patent Application No. 103380, filed Nov. 9, 2005) is incorporated by reference and its entirety as if fully set forth herein.

### TECHNICAL SCOPE OF THE INVENTION

The present invention refers to a laboratorial extrusion line that has the ability to be used for the production of conventional and bi-oriented tubular film (monolayer or multilayer), with simple commutation between the two techniques. The use of some of the components enables the production of conventional tubular film, while another set of components is used to produce bi-oriented tubular film.

This production technology is applicable to plastics.

### FRAMEWORK OF THE INVENTION

The production of high performance plastics films, i.e., films with high demanding specifications in terms of optical, mechanical and barrier properties, requires the adoption of specific technical solutions, such as the use of advanced materials, a multi-layered film structure (by co-extrusion), or the use of bi-orientation techniques. The present extrusion line tries to accommodate most of these alternatives. In an extrusion line for the production of conventional mono- or multi-layer film, a relatively thick tube is extruded/co-extruded vertically, generally upwards, and drawn simultaneously in the axial and circumferential directions immediately after exiting the extrusion die exit, therefore still in melt form. Cooling is promoted by an external air ring (forced convection) positioned above the extrusion die. Although the first patent related to this process was filed for cellulose polymers in 1915 (U.S. Pat. No. 1,163,740), its generalized industrial use tool place in the 30s and 40s, for the main thermoplastics polymers. During the subsequent decades new constructive details were developed with a view to enhance the properties of the films, such as those described in the documents of U.S. Pat. No. 3,956,254 (1976), U.S. Pat. No. 5,126,096 (1992) and U.S. Pat. No. 5,468,444 (1995).

In an extrusion line producing bi-oriented tubular (generally, multi-layer) film, a relatively thick tube (primary) is extruded/co-extruded vertically downwards and cooled down with water before being bi-axially drawn. For this purpose, the primary is driven to the bi-orientation zone where it is re-heated below its melting temperature, bi-oriented (when it is converted in a thin film) and cooled down by forced convection of air. This technology was patented in 1939 (U.S. Pat. No. 2,176,925) for cellulose polymers, and applied subsequently to the main thermoplastic polymers in the fifties and sixties. More recently, it has made possible the development of numerous technical films for specific applications, which were described in U.S. Pat. No. 4,229,241 (1980), U.S. Pat. No. 4,274,900 (1981), U.S. Pat. No. 4,532,189 (1985), U.S. Pat. No. 5,296,304 (1994) and U.S. Pat. No. 6,106,934 (2000), among others.

Therefore, the main difference between extrusion lines for conventional and bi-oriented films lyes in the temperature at which the polymer is bi-oriented, which is significantly lower for the so-called bi-oriented films (for polyethylenes, the temperature difference is circa 70 to 90° C.). In this case, the bi-axial deformation promoted by the simultaneous drawing and inflation promotes a higher degree of molecular orientation (since one is handling a highly elastic polymer kept at a temperature between its transition and melting points instead of a melt) and relaxation of the orientation is lower, because the cooling time needed after the bi-orientation step is drastically reduced.

Industrial extrusion lines, particularly those used for the production of bi-oriented films, command significant investments, yield high throughputs and, due to their dimensions and complexity, require long start-up and stabilization times. Consequently, their use to perform experimental studies with a view to develop new products, or to optimize processes, is economically prohibitive. For this reason, and to make that type studies viable, laboratory (small-scale) extrusion lines for conventional film are commercially available, but the same is not true for bi-oriented film. Thus, three types of extrusion lines for tubular film are commercially available: laboratorial lines for conventional film, industrial lines for conventional film and industrial lines for bi-oriented film. They allow the production of conventional tubular film (in small or large scale), or of bi-oriented film in large scale.

In order to clarify the differences between industrial and laboratorial scales of extrusion lines producing bi-oriented film, Table 1 shows some typical characteristics of an industrial extrusion line and those corresponding to the invention.

TABLE 1
Typical characteristics of an industrial extrusion
line for the production of bi-oriented film and
corresponding features of the invention.

| Line attribute | Industrial | Laboratorial |
|---|---|---|
| Height (m) | 25 | 3, 5 |
| Die diameter (mm) | 350 | 50 |
| Bubble diameter (m) | 1, 60 | 0, 18 |
| Die gap (mm) | 1, 5 | 1, 5 |
| Throughput (kg/h) | 250 | 4 |
| Production speed | 65 | 8, 5 |
| (m/min) | | |

A laboratorial extrusion line for the production of conventional tubular film (with one or two layers) and bi-oriented tubular film (with three layers) was invented. This tool, which good potential for R&D work, has two main innovative characteristics: i) it can be operated under two different technologies, the commutation between them being quick and simple; ii) it constitutes a small scale line for the production of bi-oriented tubular film.

Scaling down, i.e., conversion from the industrial to the laboratorial scale, was performed assuming that the polymer should sustain similar thermo-mechanical histories in both types of equipment, in order to guarantee the manufacture of films with similar characteristics and performance. Only under these conditions it is relevant to perform developments at laboratorial scale and make the scale up to industrial practice. However, this is difficult to achieve, as the available scaling up rules for extrusion concern the process inside the extruder and the cooling of conventional extrudates. Therefore, a simple but specific scale up methodology was adopted here: the primary must be geometrically adequate and with good surface quality; the morphological development is both cases must be similar. This means that parameters such as extrusion temperature, bi-orientation temperature, rates of cooling of the primary and of the film, draw-down and blow-up ratios must be identical in both types of lines. The components of the new laboratorial line were designed based on this assumption, having in mind the differences in throughputs and in cooling lengths (or times) typically available for heat transfer (primary cooling, primary re-heating and film cooling).

### SUMMARY AND ADVANTAGES OF THE INVENTION

The laboratorial extrusion line for the production of conventional and bi-oriented tubular film, aim of the present invention, maintains the general principles and functionalities of commercial industrial extrusion lines for the production of conventional and of bi-oriented tubular films, but at laboratorial scale and with the capability of exchanging between the two technologies. The advantages of this invention are the following:

Possibility to produce at laboratorial scale conventional or bi-oriented tubular film;

Swift commutation between the two types of technologies;

Use of small amounts of raw-material to manufacture films with physical and mechanical characteristics similar to those produced in industrial equipment;

Reduction of energy consumption (short start-up times due to low thermal inertia and low electrical power required).

### SHORT DESCRIPTION OF THE DRAWINGS

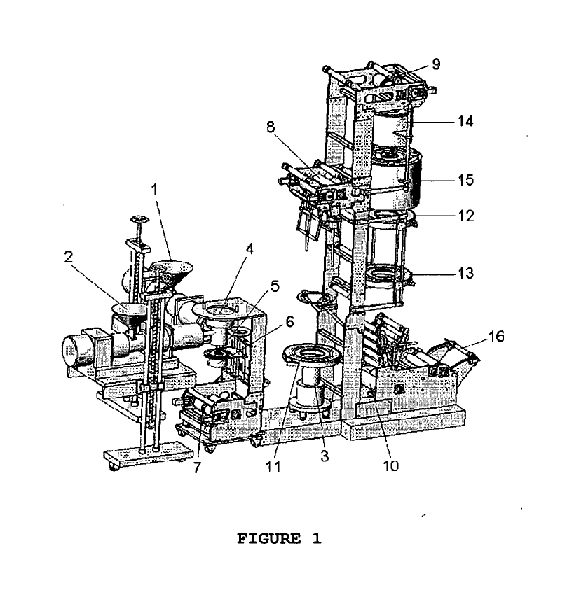

The laboratorial extrusion line for the production of conventional and bi-oriented tubular film is illustrated in FIG. 1. It encompasses two movable extruders with adjustable height (1 and 2), one co-extrusion die for the production of conventional film with one or two layers (3), one co-extrusion die (three layers) for the production of bi-oriented film (4), one unit for internal calibration/cooling of the primary (5), one water ring for the external cooling of the primary (6), four sets of pulling rolls (7 to 10), three air rings to cool down the film (11 to 13), two units for thermal conditioning of the primary (14 and 15) and one winding unit (16).

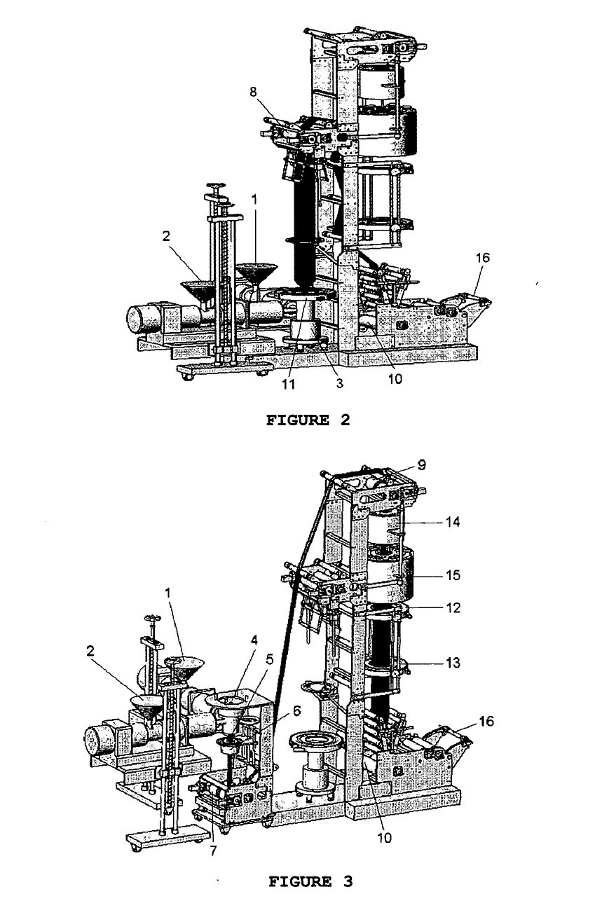

The set-up for the production of conventional and bi-oriented film is illustrated in FIGS. 2 and 3, respectively.

### DETAILED DESCRIPTION OF THE INVENTION

The laboratorial extrusion line, reason of the present invention, encompasses a set of components that enables commutation between the production of conventional and bi-oriented film.

The path of the polymer along the line and the components involved in the production of conventional tubular film, with two layers, is illustrated in FIG. 2. The following components are used: two single-screw extruders (1 and 2), with their barrels positioned at the lower level, coupled to the extrusion die for conventional film (3); one air ring to cool down the bubble (film) immediately after the extrusion die exit (11); one pair of pulling rolls (8) that defines the draw-down ratio the melt is subjected to; one pair of pulling rolls (10) that must rotate at a similar velocity to (8) to maintain the film under tension along the line without stretching it; one winding unit (16) to store the film produced.

The components used for the production of co-extruded (up to three layers) bi-oriented tubular film and the resulting path of the polymer are illustrated in FIG. 3. With this option, the following components are relevant: two single screw extruders (1 and 2), now working at their highest level, coupled to the three layer co-extrusion die (4); one unit for the internal calibration/cooling of the primary (5), one water ring for the external cooling of the primary (6), one pair of pulling rolls (7) that maintains the primary under tension without stretching (or slightly stretching), one pair of pulling rolls (9) that must rotate at a similar velocity to (7) to maintain the primary under tension along the line without stretching it; two thermal conditioning units (14 and 15), to heat the primary up to the bi-orientation temperature, two independent air rings (12 and 13) to cool down the bubble(film); one pair of pulling rolls (10), to define the draw-down ratio; one winding unit (16) to store the film produced.

The invention claimed is:

1. Modular laboratorial extrusion line for the production of mono- or multi-layered conventional and bi-oriented tubular film, with manual commutation between the two techniques, characterized by being comprising two movable extruders (1 and 2), one extrusion die for production of conventional film (3), one extrusion die for production of bi-oriented film (4), one unit for internal calibration/cooling of the primary (5), one water ring for external cooling of the primary (6), four sets of pulling rolls (7 to 10), three air rings to cool down the film (11 to 13), two units for thermal conditioning of the primary (14 and 15) and one winding unit (16), the components (1), (2), (6), (12) and (13) having adjustable height.

2. Modular laboratorial extrusion line in accordance with claim 1, characterized by using components (1), (2), (3), (11), (8), (10) and (16) for the production of conventional tubular film.

3. Modular laboratorial extrusion line, according to claim 1, characterized by using components (1), (2), (4), (5), (6), (7), (9), (14), (15), (12), (13), (10) and (16) for the production of bi-oriented tubular film.

4. Modular laboratorial extrusion line, according to claim 1, characterized by producing films with throughputs lower than 5 kg/h.

5. Modular laboratorial extrusion line, according to claim 1, characterized by its height being equal or lower than 4,4 m.

6. Modular laboratorial extrusion line, according to claim 1, able to produce conventional film through the use of two extruders (1 and 2), extrusion die for conventional film (3), one air cooling ring (11), two sets of pulling rolls (8 and 10) and one winding unit (16), utilized in this same sequence.

7. Modular laboratorial extrusion line, according to claim 1, characterized by being able to produce bi-oriented film through the use of two extruders (1 and 2), extrusion die for bi-oriented film (4), unit for the internal calibration/cooling of the primary (5), water ring for the external cooling of the primary (6), one first set of pulling rolls (7), one second set of pulling rolls (9), two units for the thermal conditioning of the primary (14 and 15), two air rings to cool down the film (12 and 13), a third set of pulling rolls (10) and one winding unit (16), utilized in this sequence.
